(19) United States
(12) Patent Application Publication
(10) Pub. No.: US 2008/0046329 A1
(43) Pub. Date: Feb. 21, 2008

(54) Allowing a Bidder to Group Lots in Online Auctions

(76) Inventor: Bryan M. Logan, Rochester, MN (US)

Correspondence Address: IBM (ROC-BLF), C/O BIGGERS & OHANIAN, LLP, P.O. BOX 1469, AUSTIN, TX, 78767-1469, US

(21) Appl. No.: 11/465,334

(22) Filed: Aug. 17, 2006

(51) Int. Cl. G06Q 30/00

(52) U.S. Cl. 705/26

(57) ABSTRACT

Allowing a bidder to group lots in online auctions, including receiving in an online auction server an instruction from a grouping bidder to combine at least two separate lots from separate online auctions into a group lot; combining by the online auction server the at least two separate lots into a group lot for bids from the grouping bidder; receiving in the online auction server a bid from the grouping bidder on the group lot; and applying by the online auction server the bid from the grouping bidder on the group lot to the at least two separate lots.

### BACKGROUND OF THE INVENTION

1. Field of the Invention

The field of the invention is data processing, or, more specifically, methods, systems, and products for allowing a bidder to group lots in online auctions.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

One of the areas where computer technology has advanced in recent years is online auctions. Online auctions enable sellers to list items for sale (called ‘lots’) on an online auction server, upload descriptions and images of the items or lots, establish prices, delivery terms, the period of the auction, and the like, and carry out online auctions for the lots. An online auction server displays lots for sale to bidders, and the bidders can bid on lots through the online auction server.

A ‘lot,’ as the term in used here, is a number of units of an article, a single article, or a parcel of articles offered for sale as one item in an online auction. When someone is selling multiple items in an online auction, each item typically is bid on individually unless the seller groups those items into a single lot. However, when the seller groups the items, buyers may not want to purchase the lot if they just want a single item. This can potentially drive away some buyers.

For example, a seller has items A and B for sale. They are different items with different values. Emma wants item A and she'll pay a maximum of $20.00 for it. Brent wants item B, and he is willing to pay a maximum of $60.00 for it. Amie wants both, and she is willing to pay a maximum of $90.00 for both. In current art, Emma can submit a maximum proxy bid of $20.00; Brent can bid a proxied maximum of $60.00; and Amie would have to split her bid amount between the two items. If Amie splits her bid as $55.00 for item B and $35.00 for item A, Amie will win only item A, losing item B. Item A would go for $21.00 dollars to Amie, and item B would go for $56.00 to Brent. The seller receives $77.00.

The ‘proxy’ bidding mentioned above is an automated form of bidding commonly supported by online auction server application programs today. When a bidder place a bid, the bidders enters the maximum amount the bidder is willing to pay for an item. That maximum amount is kept confidential from other bidders and the seller. The online auction server application program compares the bidder's bid to those of the other bidders. The online auction application program places bids on the bidder's behalf, using only as much of the maximum bid amount as is necessary to maintain the high bid position—or to meet a reserve price. The online auction application program will bid up to the maximum bid amount. If another bidder has a higher maximum, the first bidder will be outbid. If no other bidder has a higher maximum, the first bidder wins the item. The bidder can, however, and often will, pay less than the entered maximum bid amount. In this way, a bidder is not required to keep coming back to re-bid every time another bid is placed.

Another example with items A and B: If the seller believed that items A and B would be a good combination, the seller could combine them into a single lot. In this example, however, Emma has already purchased item B from another source. Emma therefore proxy bids $20.00 for the lot A and B—because that is the maximum she is willing to spend for item A. Brent in this example does not care about item A. Brent proxy bids $60.00 for the lot A and B. Amie puts in her maximum proxy bid of $90.00 for the lot, and ends up getting it for $61.00, beating Brent's maximum proxy bid of $60.00. The seller, therefore, actually lost $16.00 dollars by combining items A and B into a single lot compared with what the seller would have received by selling items A and B in separate lots as described above.

### SUMMARY OF THE INVENTION

Methods, apparatus, and computer program products are disclosed for allowing a bidder to group lots in online auctions by receiving in an online auction server an instruction from a grouping bidder to combine at least two separate lots from separate online auctions into a group lot; combining by the online auction server the at least two separate lots into a group lot for bids from the grouping bidder; receiving in the online auction server a bid from the grouping bidder on the group lot; and applying by the online auction server the bid from the grouping bidder on the group lot to the at least two separate lots.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for allowing a bidder to group lots in online auctions according to embodiments of the present invention.

FIG. 2 sets forth a block diagram of automated computing machinery comprising an exemplary computer (152) useful in allowing a bidder to group lots in online auctions according to embodiments of the present invention.

FIG. 3 sets forth a flow chart illustrating an exemplary method for allowing a bidder to group lots in online auctions according to embodiments of the present invention.

### DETAILED DESCRIPTION OF EXEMPLARY EMBODIMENTS

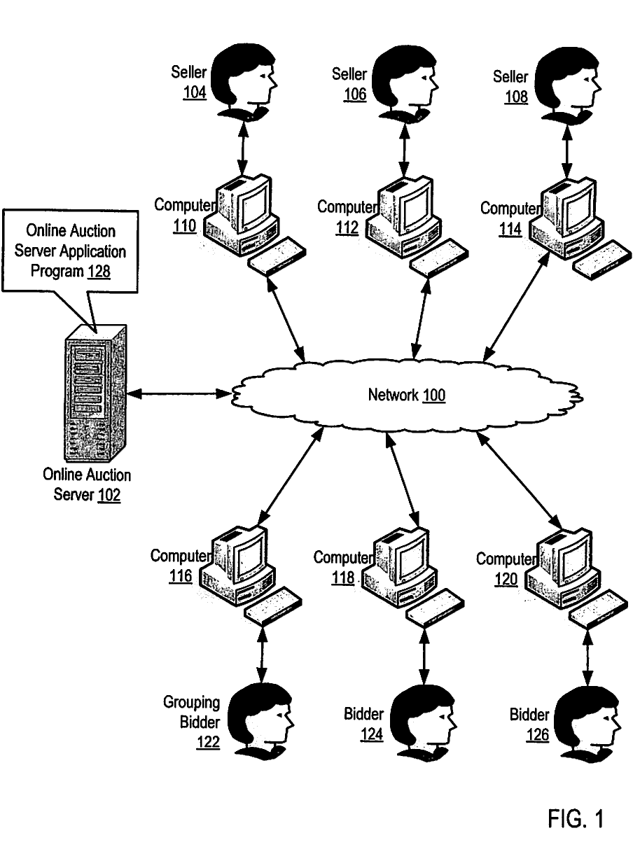

Exemplary methods, systems, and products for allowing a bidder to group lots in online auctions according to embodiments of the present invention are described with reference to the accompanying drawings, beginning with FIG. 1. FIG. 1 sets forth a network diagram illustrating an exemplary system for allowing a bidder to group lots in online auctions according to embodiments of the present invention. The system of FIG. 1 includes sellers (104, 106, 108) engaged in auctioning items in lots in online auctions implemented by an online auction server application program (128) on online auction server (102). The sellers communicate with the online auction server through computers (110, 112, 114) which are coupled for data communications to online auction server (102) through data communications network (100). The seller's list items in lots for sale on the online auction server, upload descriptions and images of the items to the online auction server, establish prices, delivery terms, the periods of the auctions, and carry out online auctions for the lots. The system of FIG. 1 also includes bidders (122, 124, 126) engaged in bidding for items in lots in online auctions implemented by the online auction server application program (128) on the online auction server (102). The bidders communicate with the online auction server through computers (116, 118, 120) which are coupled for data communications to online auction server (102) through data communications network (100). The online auction server displays lots for sale to bidders, and the bidders can bid on lots through the online auction server.

In the example of FIG. 1, the online auction server application program is a module of computer program instructions that cause the system of FIG. 1 to operate generally to allow a bidder to group lots in online auctions according to embodiments of the present invention by receiving in an online auction server an instruction from a grouping bidder to combine at least two separate lots from separate online auctions into a group lot; combining by the online auction server the at least two separate lots into a group lot for bids from the grouping bidder; receiving in the online auction server a bid from the grouping bidder on the group lot; and applying by the online auction server the bid from the grouping bidder on the group lot to the at least two separate lots. Combining separate lots into a group lot optionally may be limited to combining only lots from separate online auctions that are scheduled to terminate at the same time—or to separate lots offered for sale in separate online auctions by the same seller.

By allowing a bidder to group lots in online auctions according to embodiments of the present invention, an online auction server application may provided a way for a bidder to choose what items to combine into a group lot independently of the actions of other bidders. The fact that a bidder has combined separate lots into a group lot may be entirely unknown to other bidders, leaving other bidders to bid separately on the separate lots in the separate online auctions—while a grouping bidder at the same time bids on the separate lots as a single group lot. In addition, allowing a bidder to group lots in online auctions according to embodiments of the present invention typically maximize sales revenue for the seller and the auction site (the auction site typically is paid a portion of the proceeds of online auction sales).

For further explanation, consider the following continuation of the above example of auctioning of items A and B while allowing a bidder to group lots in online auctions according to embodiments of the present invention: In this example, Amie is allowed by the online auction server to bid on the two items A and B as a group lot, while at the same time Emma and Brent continue to bid on item A and item B as separate lots in separate online auctions. Amie would win both for $81.00 dollars, because that amount is greater than the combined maximum bids for Emma and Brent. In this example, the seller receives an additional $4.00 compared with the $77.00 received when selling items A and B in separate lots according to the prior art as described above. Since auction sites are paid a portion of the proceeds, the auction site also earns more. In addition, the seller can save expenses on shipping because the two items are going to the same buyer.

The arrangement of servers and other devices making up the exemplary system illustrated in FIG. 1 are for explanation, not for limitation. Data processing systems useful for allowing a bidder to group lots in online auctions according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

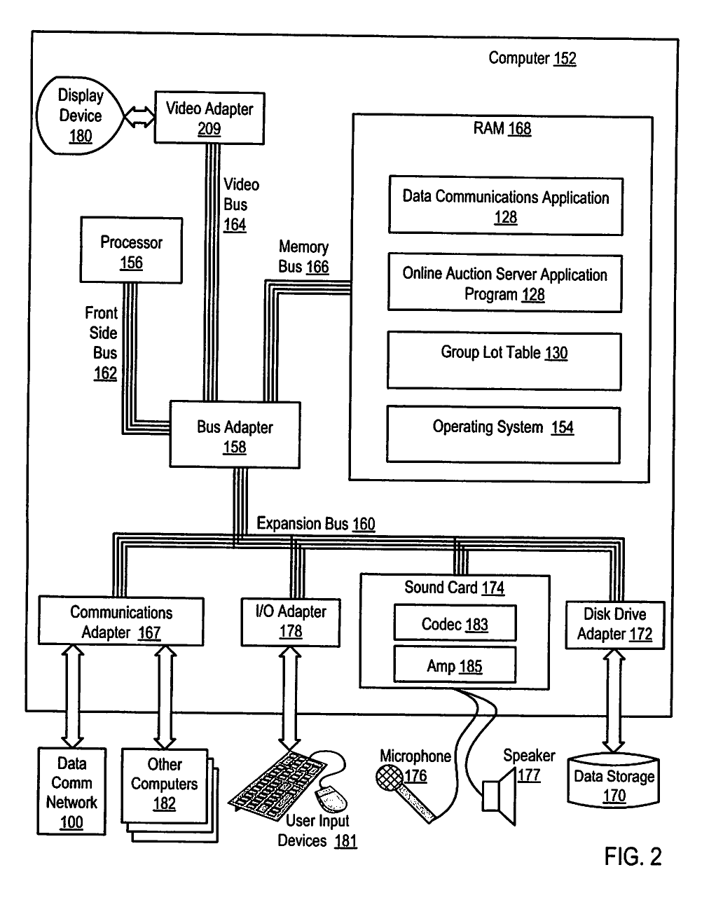

Allowing a bidder to group lots in online auctions in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in allowing a bidder to group lots in online auctions according to embodiments of the present invention. The computer (152) of FIG. 2 may be configured to function as an online auction server (reference 102 on FIG. 1) or as a computer (references 116, 118, 120 on FIG. 1) for use by a bidder in grouping lots in online auctions.

The computer (152) of FIG. 2 includes at least one computer processor (156) or ‘CPU’ as well as random access memory (168) (‘RAM’) which is connected through a system bus (160) to processor (156) and to other components of the computer. Stored in RAM (168) is a data communications application (127), a module of computer program instructions for conducting data communications between bidder computers and online auction servers for online auctions. On bidder computers, such a data communications application may often be represented by an HTTP (HyperText Transport Protocol) client communications application such as a web browser. On an online auction server, such a data communications application may be represented by a web server (HTTP server), a TCP/IP engine, or other data communications applications as will occur to those of skill in the art.

Also stored RAM (168) is an online auction server application program (128), a module of computer program instructions for carrying out online auctions by allowing sellers to register lots for sale in auctions and bidder to place bids on the lots. In addition, the online auction server application program (128) in this example is programmed to allow a bidder to group lots in online auctions according to embodiments of the present invention by receiving in an online auction server an instruction from a grouping bidder to combine at least two separate lots from separate online auctions into a group lot; combining by the online auction server the at least two separate lots into a group lot for bids from the grouping bidder; receiving in the online auction server a bid from the grouping bidder on the group lot; and applying by the online auction server the bid from the grouping bidder on the group lot to the at least two separate lots. The online auction server application program (128) optionally may be programmed according to embodiments of the present invention to combine separate lots into a group lot only for separate lots from separate online auctions that are scheduled to terminate at the same time—or for separate lots offered for sale in separate online auctions by the same seller. Also stored in RAM (168) is a group lot table (130), a data repository in computer memory for use in combing separate lots into a group lot for bids from a grouping bidder.

Also stored in RAM (168) is an operating system (154). Operating systems useful in computers that support bidders' grouping lots in online auctions according to embodiments of the present invention include UNIX™, Linux™, Microsoft NT™, AIX™, IBM's i5/OS™, and others as will occur to those of skill in the art. Data communications application (127), online auction server application program (128), group lot table (130), and operating system (154) in the example of FIG. 2 are shown in RAM (168), but many components of such software typically are stored in non-volatile memory also, for example, on a disk drive (170).

The computer (152) of FIG. 2 includes a bus adapter (158), a computer hardware component that contains drive electronics for the high speed buses, the front side bus (162), the video bus (164), and the memory bus (166), as well as for the slower expansion bus (160). Examples of bus adapters useful in computers according to embodiments of the present invention include the Intel Northbridge, the Intel Memory Controller Hub, the Intel Southbridge, and the Intel I/O Controller Hub. Examples of expansion buses useful in computers according to embodiments of the present invention include Industry Standard Architecture (‘ISA’) buses and Peripheral Component Interconnect (‘PCI’) buses.

Computer (152) of FIG. 2 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers include Integrated Drive Electronics (‘IDE’) adapters, Small Computer System Interface (‘SCSI’) adapters, and others as will occur to those of skill in the art. In addition, non-volatile computer memory may be implemented for a computer as an optical disk drive, electrically erasable programmable read-only memory space (so-called ‘EEPROM’ or ‘Flash’ memory), RAM drives, and so on, as will occur to those of skill in the art.

The example computer of FIG. 2 includes one or more input/output (‘I/O’) adapters (178). I/O adapters in computers implement user-oriented input/output through, for example, software drivers and computer hardware for controlling output to display devices such as computer display screens, as well as user input from user input devices (181) such as keyboards and mice. The example computer of FIG. 2 includes video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer of FIG. 2 also includes a sound card (174), which is an example of an I/O adapter specially designed for accepting analog audio signals from a microphone (176) and converting the audio analog signals to digital form for further processing by a codec (183). The sound card (174) is connected to processor (156) through expansion bus (160), bus adapter (158), and front side bus (162).

The exemplary computer (152) of FIG. 2 includes a communications adapter (167) for data communications with other computers (182) and for data communications with data communications network (100). Such data communications may be carried out through serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for allowing a bidder to group lots in online auctions according to embodiments of the present invention include modems for wired dial-up communications, Ethernet (IEEE 802.3) adapters for wired data communications network communications, and 802.11b adapters for wireless data communications network communications.

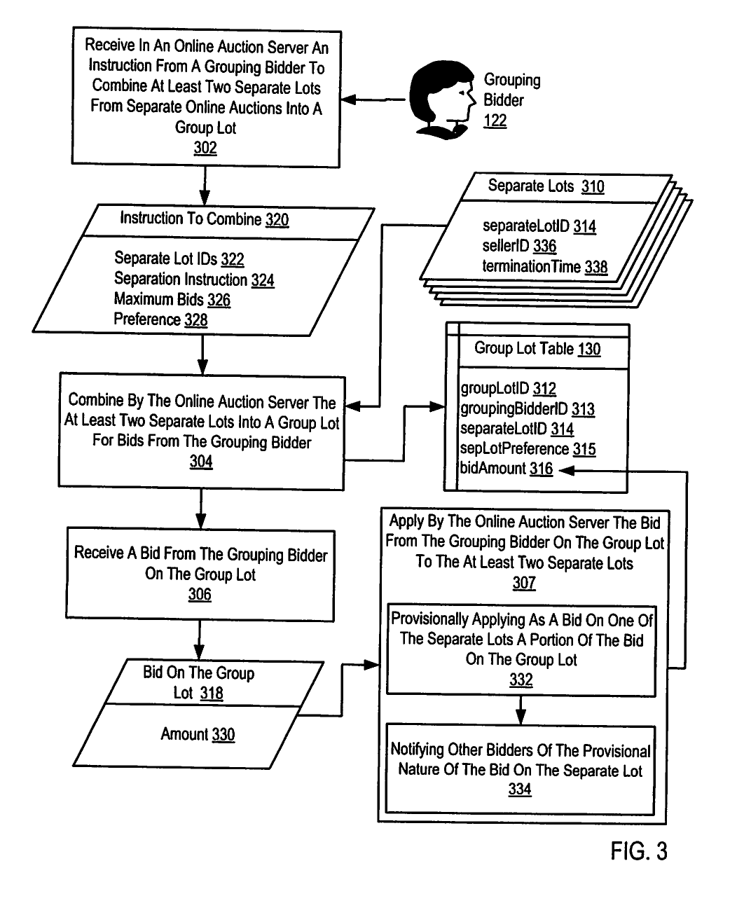

For further explanation, FIG. 3 sets forth a flow chart illustrating an exemplary method for allowing a bidder to group lots in online auctions according to embodiments of the present invention. The processing described as the method of FIG. 3 is carried out generally in an online auction server such the one described above with regard to reference (102) of FIG. 1. The method of FIG. 3 includes receiving (302) in the online auction server an instruction (320) from a grouping bidder to combine at least two separate lots (310) from separate online auctions into a group lot. Each bidders' computer (116, 118, 120 on FIG. 1) typically supports a graphical user interface (‘GUI’) upon which the online auction server causes to be displayed lists of items in lots available for combining into group lots. The lists can be created by the online auction server application program by sorting items in lots in auctions by category, brand, model number, type, by keywords in descriptions, and in other ways as will occur to those of skill in the art. Any bidder can become a grouping bidder by selecting two or more separate lots to be combined into a group lot and advising the online auction server of the selection through the GUI, by data communications means over a data communications network, such as, for example, the network illustrated at reference 100 on FIG. 1.

The method of FIG. 3 also includes combining (304) by the online auction server the at least two separate lots (310) into a group lot for bids from the grouping bidder. In the method of FIG. 3, the combining of the at least two separate lots into a group lot for bids from the grouping bidder may be unknown to other bidders, leaving other bidders to bid separately on the at least two separate lots in the separate online auctions. In the method of FIG. 3, combining (304) the at least two separate lots into a group lot for bids from the grouping bidder may be carried out by combining the at least two separate lots into a group lot only if the separate online auctions are scheduled to terminate at the same time. Combining only lots whose separate auctions terminate at the same time is not actually a requirement of the invention, but this limitation is so useful in simplifying the administration of auctions in which bidders are allowed to group lots that it is said to be preferred.

Also in the method of FIG. 3, combining the at least two separate lots into a group lot for bids from the grouping bidder may be carried out by combining the at least two separate lots into a group lot only if the at least two separate lots are offered for sale in the separate online auctions by the same seller. Again, this is not actually a requirement of the invention, but it is preferred. The amount each seller receives can be determined by the final portion of a group lot bid as applied to each separate lot in the group lot. It is possible, however, that the amount to be applied to any particular item individually could be skewed if the individual item is undervalued by other bidders. For this reason, it is preferred to be able to apply all bid amounts for a group lot to lots offered by the same seller. Limiting group lots to a single seller reduces this concern because the seller always receives an amount that is higher for each individual item than was offered by bidders other than the winner.

In the example of FIG. 3, combining separate lots into a group lot is carried out by use of a group lot table (130). Each record in the group lot table (130) represents a separate lot that has been combined with one or more other separate lots into a group lot. Each record of the group lot table in this example includes a field named groupLotID (312) for storing an identification code for a group lot. Each record of the group lot table in this example includes a field named separateLotID (314) for storing an identification code for each separate lot in a group lot. Each record of the group lot table in this example includes a field named sepLotPreference (315) for storing an indication of bidder preference for the separate lots combined in a group lot. And each record of the group lot table in this example includes a field named bidAmount (316) for storing an amount representing the portion of a bid from a grouping bidder that is applied to each separate lot of a group lot. A group lot is represented in the group lot table (310) by a set of records each of which bears the same value of groupLotID (312). Each record in such a set will have a different value of separateLotID (314). And each record in such a set will bear a value in bidAmount (316) representing the portion of a group lot bid that is applied to the separate lot represented by the record. The use of a table for combining separate lots into a group lot in this example is for explanation only, not for limitation of the invention. Other structures could be used for combining separate lots into a group lot as will occur to those of skill in the art, including, for example, linked lists, hash tables, arrays, arrays of C-style data structures, and so on.

In the method of FIG. 3, the instruction (320) from the grouping bidder to combine at least two separate lots from separate online auctions into a group lot may also include:
an instruction (324) to separate the group lot back into the separate lots for application of the grouping bidder's bids if the grouping bidder cannot win the group lot with the grouping bidder's current bid on the group lot,
maximum bids (326) to be applied to each of the separate lots by the online auction server as proxy, and
an indication (328) of the grouping bidder's preference among the separate lots.

In this way, a grouping bidder can limit the amounts to be spent on the separate lots in a group lot. Consider an example of a grouping bidder who submits a proxy maximum bid of $100.00 on a group lot that is a combination of three separate lots representing items A, B, and C. The grouping bidder may include in the grouping instruction that created the group lot maximum bids to be applied to each of the separate lots, for example, a maximum of $50.00 for item A, $40.00 for item B, and $20.00 for item C. The grouping bidder can indicate a preference, in order of decreasing preference, of: item A, item B, item C. At the end of the auction, the online auction server application program will determine whether the grouping bidder can win all three items for $100, and, if not, try for the items individually. If the grouping bidder can win item A individually for $50.00 and win item B for $35.00, when item C would cost $18 (because the highest bid on item C from another bidder was $17.00), the grouping bidder would not win item C, because the amount left over from the $100.00 proxy bid after buying item A and item B is only $15.00.

Note that an instruction (324) to separate a group lot back into separate lots for application of the grouping bidder's bids if the grouping bidder cannot win the group lot with the grouping bidder's current bid on the group lot—is optional. In the absence of such an instruction, the grouping bidder's bids are applied so as to win the entire group lot or nothing. Without such a separation instruction, if the grouping bidder's bids cannot be applied to the separate lots in the group so that the grouping bidder wins all separate lots in the group lot, the grouping bidder loses the auction entirely.

The method of FIG. 3 also includes receiving (306) in the online auction server a bid (306) from the grouping bidder on the group lot. In this example, the group lot bid (318) includes a bid amount (330) which is to be applied by an online auction server application program to separate lots of a group lot. Such a group lot bid typically is submitted through a GUI of a grouping bidder's computer, often through a browser, and across a network through data communications means such as HTTP, TCP/IP, and so on. Such a group lot bid may be represent a single bid amount to be applied once to the separate lots in a group lot, or such a bid may be a proxy bid representing a maximum amount to be applied by an online auction server application program to separate lots of a group lots in amounts just large enough to win over bids from other bidders on the separate lots of a group lot.

The method of FIG. 3 also includes applying (307) by the online auction server the bid from the grouping bidder on the group lot to the at least two separate lots. In the method of FIG. 3, applying (307) the bid from the grouping bidder on the group lot to the separate lots of a group lot is carried out by applying the bid from the grouping bidder to each of the separate lots in dependence upon bids received on the separate lots from other bidders. That is, the bid on the group lot is apportioned among the separate lots in the group lot. If, for example, a group lot is a combination of item A and item B from separate lots, and item A has a bid of $10.00 and item B has a bid of $15.00 when items A and B are combined into a group by a grouping bidder who bids a maximum proxy bid of $50.00 for both items, an online auction server application program, upon receiving the $50.00 bid, will apply as a proxy on behalf of the grouping bidder a bid of $11.00 on item A and a bid of $16.00 on item B, just enough on each item to win against the previous bids from other bidders.

Such ‘other bidders,’ it is useful to note, may be other grouping bidders as well as non-grouping bidders. Each group lot is established by a single grouping bidder. Other grouping bidders, however, may establish group lots of separate lots that may overlap, include some separate lots that are also included in other group lots. Or a grouping bidder may even combine into a group lot the same set of separate lots combined into another group lot by another grouping bidder—which is why each record in the group lot table (130) in this example bears a field named groupingBidderID for storing an identifier of the grouping bidder who created each group lot—to link each group lot to the grouping bidder who created the group lot—because each group lot could possibly include exactly the same set of separate lots that is also in another group lot. With proxy bidding among grouping bidders and non-grouping bidders, there may be several or many permutations of bid amount applications available to an online auction server application operating as a proxy. When an auction ends, the online auction server application program can run various permutations to determine who wins the auction. The winning permutation is the permutation that stays within the bid limits on group lots (or individual item limits established by grouping bidders on separate lots within group lots) while generating maximum revenue for the seller.

In the method of FIG. 3, applying (307) by the online auction server the bid from the grouping bidder on the group lot to the at least two separate lots may also include provisionally (332) applying as a bid on one of the separate lots a portion of the bid on the group lot and notifying (334) other bidders of the provisional nature of the bid on the separate lot. The provisionally applied bid may be an amount applied as a bid that is higher than a maximum bid specified by the grouping bidder for the one of the separate lots.

One challenge in allowing bidders to group lots involves displaying the current leader of an auction while the auction is ongoing. Since a grouping bidder's bid amount is to be applied across separate lots in a group lot, there is a possibility that a bid amount can be applied to a separate lot that is larger than a maximum limit set for the separate lot—and still meet the overall limit set for the group lot as whole. Such an overbid is said to be ‘provisionally applied,’ because it will not be left in place if doing so would ultimately violate the maximum proxy bid amount for the group lot. However, if the group lot is separated, and the grouping bidder's bid is converted to individual amounts on one or more separate lots (within their limits), such a provisional overbid on an individual item may need to be decreased later in the auction process.

TABLE 1
Bidding Example: Separate Items A and
B Combined In A Group, Proxy Bidding

| | Item A | Item B |
|---|---|---|
| Bid Descriptions | Amount and Leader | Amount and Leader |
| Vonnie, Item A, $19 | $1, Vonnie | No Bid |
| Cheryl, Item B, $54 | $1, Vonnie | $1, Cheryl |
| Carl, Item A, $20 | $20, Carl | $1, Cheryl |
| Brent, Item B, $55 | $20, Carl | $55, Brent |
| Amie, Group Lot A + B, $90. | $21, Amie | $56, Amie |
| Instruction to separate lots if | | |
| unwinnable as a group lot. | | |
| $30 max on item A | | |
| $70 max on item B | | |
| Prefer item B | | |
| Emma, Item A, $33 | $34, Amie*** | $56, Amie |
| Jason, Item B, $58 | $32, Emma | $59, Amie |

Table 1 illustrates a bidding process with such a provisional overbid. When Emma bids $33.00 on item A, Amie can still get the group lot for $90.00 ($34.00+$56.00), but Amie's maximum for item A alone is $30.00. So the online auction server application applies $34.00 as a proxy bid for Amie for item A and marks it as provisional with asterisks. When other bidders look at the display of the leader, they realize that later auction events and events in other auctions could decrease this amount. Amie's bid is still working as a bid on the group lot, and Amie temporarily exceeds her maximum individual limit on item A as long as her overall limit on the group lot is not exceeded.

When Jason puts in a bid for $58.00 on item B, Amie can no longer win the group lot with Amie's maximum proxy bid amount of $90.00—because Emma's $33.00 bid for item A and Jason's $58.00 bid for item B mean that the group lot can now only be won with a bid of at least $34.00+$59.00=$93.00.

Amie's bid included an instruction to separate the lots in the group lot if she could not win the group lot and bid a maximum of $70.00 on item B with a preference for item B. The online auction server application in this example proceeds by satisfying Amie's expressed preference for item B, applying $59.00 of Amie's bid amount to item B, meeting both Amie's individual limit of $70.00 for item B and Amie's overall bid limit of $90.00. Note that this bid is not marked as a provisional bid because there is nothing that could occur in the bidding process that would require lowering this bid, because it is still under the individual item limit and has first priority for the overall budget of $90.00. The portion of Amie's $90.00 overall bid amount available to be applied to item A is now only $31.00 ($90.00−$59.00). Because Emma has a maximum bid of $33.00 for item A, Emma becomes the leader in the bidding for item A with $32.00. Note that even though the bid amount for item A decreased from $34.00 to $32.00, the seller's total sales amount for both items A and B has actually increased.

If Jason had put in a bid for $57.00 instead of $58.00, then the $90.00 maximum limit on Amie's group lot bid could still be met with $33.00 on item A and $57.00 on item B. Because Amie's group lot bid was placed before both Emma's bid on item A and Jason's bid on item B, the tiebreaker would go to Amie.

If another user creates additional bids to be a conditional bid and the conditional bid is removed because of another auction's status, then the proxy bidding will put the user at the lowest amount required to beat additional bidders. While some bidders may be surprised by being in 2nd place and then winning, the result is that they will never pay more than they agreed to on their maximum bid. In a “sealed-bid” auction, the problems of displaying the current leader and how to apply bid amounts across individual items disappears because it only needs to be calculated and displayed at the end of the auction. The final price on all separate lots in a group lot (if won by a group lot bid) will always be greater than the highest bid by other bidders bidding separately on the separate lots. In regards to a reserve price, a reserve price can simply be treated as a bid by the seller than the other bidders would have to beat in the same manner.

Exemplary embodiments of the present invention are described largely in the context of a fully functional computer system for allowing a bidder to group lots in online auctions. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of allowing a bidder to group lots in online auctions, the method comprising:
receiving in an online auction server an instruction from a grouping bidder to combine at least two separate lots from separate online auctions into a group lot;
combining by the online auction server the at least two separate lots into a group lot for bids from the grouping bidder;
receiving in the online auction server a bid from the grouping bidder on the group lot; and
applying by the online auction server the bid from the grouping bidder on the group lot to the at least two separate lots.

2. The method of claim 1 wherein the combining of the at least two separate lots into a group lot for bids from the grouping bidder is unknown to other bidders, leaving other bidders to bid separately on the at least two separate lots in the separate online auctions.

3. The method of claim 1 wherein combining the at least two separate lots into a group lot for bids from the grouping bidder further comprises combining the at least two separate lots into a group lot only if the separate online auctions are scheduled to terminate at the same time.

4. The method of claim 1 wherein combining the at least two separate lots into a group lot for bids from the grouping bidder further comprises combining the at least two separate lots into a group lot only if the at least two separate lots are offered for sale in the separate online auctions by the same seller.

5. The method of claim 1 wherein the instruction from the grouping bidder to combine at least two separate lots from separate online auctions into a group lot further comprises:
an instruction to separate the group lot back into the separate lots for application of the grouping bidder's bids if the grouping bidder cannot win the group lot with the grouping bidder's current bid on the group lot,
maximum bids to be applied to each of the separate lots by the online auction server as proxy, and
an indication of the grouping bidder's preference among the separate lots.

6. The method of claim 5 wherein applying by the online auction server the bid from the grouping bidder on the group lot to the at least two separate lots further comprises:
provisionally applying as a bid on one of the separate lots a portion of the bid on the group lot, the provisionally applied bid having a value higher than a maximum bid specified by the grouping bidder for the one of the separate lots; and
notifying other bidders of the provisional nature of the bid on the separate lot.

7. An apparatus for allowing a bidder to group lots in online auctions, the apparatus comprising a computer processor, a computer memory operatively coupled to the computer processor, the computer memory having disposed within it computer program instructions capable of:
receiving in an online auction server an instruction from a grouping bidder to combine at least two separate lots from separate online auctions into a group lot;
combining by the online auction server the at least two separate lots into a group lot for bids from the grouping bidder;
receiving in the online auction server a bid from the grouping bidder on the group lot; and
applying by the online auction server the bid from the grouping bidder on the group lot to the at least two separate lots.

8. The apparatus of claim 7 wherein the combining of the at least two separate lots into a group lot for bids from the grouping bidder is unknown to other bidders, leaving other bidders to bid separately on the at least two separate lots in the separate online auctions.

9. The apparatus of claim 7 wherein combining the at least two separate lots into a group lot for bids from the grouping bidder further comprises combining the at least two separate lots into a group lot only if the separate online auctions are scheduled to terminate at the same time.

10. The apparatus of claim 7 wherein combining the at least two separate lots into a group lot for bids from the grouping bidder further comprises combining the at least two separate lots into a group lot only if the at least two separate lots are offered for sale in the separate online auctions by the same seller.

11. The apparatus of claim 7 wherein the instruction from the grouping bidder to combine at least two separate lots from separate online auctions into a group lot further comprises:
an instruction to separate the group lot back into the separate lots for application of the grouping bidder's bids if the grouping bidder cannot win the group lot with the grouping bidder's current bid on the group lot,
maximum bids to be applied to each of the separate lots by the online auction server as proxy, and
an indication of the grouping bidder's preference among the separate lots.

12. The apparatus of claim 11 wherein applying by the online auction server the bid from the grouping bidder on the group lot to the at least two separate lots further comprises:
provisionally applying as a bid on one of the separate lots a portion of the bid on the group lot, the provisionally applied bid having a value higher than a maximum bid specified by the grouping bidder for the one of the separate lots; and
notifying other bidders of the provisional nature of the bid on the separate lot.

13. A computer program product for allowing a bidder to group lots in online auctions, the computer program product disposed upon a signal bearing medium, the computer program product comprising computer program instructions capable of:
receiving in an online auction server an instruction from a grouping bidder to combine at least two separate lots from separate online auctions into a group lot;
combining by the online auction server the at least two separate lots into a group lot for bids from the grouping bidder;
receiving in the online auction server a bid from the grouping bidder on the group lot; and
applying by the online auction server the bid from the grouping bidder on the group lot to the at least two separate lots.

14. The computer program product of claim 13 wherein the signal bearing medium comprises a recordable medium.

15. The computer program product of claim 13 wherein the signal bearing medium comprises a transmission medium.

16. The computer program product of claim 13 wherein the combining of the at least two separate lots into a group lot for bids from the grouping bidder is unknown to other bidders, leaving other bidders to bid separately on the at least two separate lots in the separate online auctions.

17. The computer program product of claim 13 wherein combining the at least two separate lots into a group lot for bids from the grouping bidder further comprises combining the at least two separate lots into a group lot only if the separate online auctions are scheduled to terminate at the same time.

18. The computer program product of claim 13 wherein combining the at least two separate lots into a group lot for bids from the grouping bidder further comprises combining the at least two separate lots into a group lot only if the at least two separate lots are offered for sale in the separate online auctions by the same seller.

19. The computer program product of claim 13 wherein the instruction from the grouping bidder to combine at least two separate lots from separate online auctions into a group lot further comprises:
an instruction to separate the group lot back into the separate lots for application of the grouping bidder's bids if the grouping bidder cannot win the group lot with the grouping bidder's current bid on the group lot,
maximum bids to be applied to each of the separate lots by the online auction server as proxy, and
an indication of the grouping bidder's preference among the separate lots.

20. The computer program product of claim 19 wherein applying by the online auction server the bid from the grouping bidder on the group lot to the at least two separate lots further comprises:
provisionally applying as a bid on one of the separate lots a portion of the bid on the group lot, the provisionally applied bid having a value higher than a maximum bid specified by the grouping bidder for the one of the separate lots; and
notifying other bidders of the provisional nature of the bid on the separate lot.
